(19) United States
(12) Patent Application Publication
(10) Pub. No.: US 2025/0355156 A1
(43) Pub. Date: Nov. 20, 2025

(54) WAVEGUIDE DEVICE AND OPTICAL DEVICE USING THE SAME

(71) Applicant: HTC Corporation, Taoyuan City (TW)

(72) Inventor: Qing-Long DENG, Taoyuan City (TW)

(21) Appl. No.: 19/208,603

(22) Filed: May 15, 2025

Related U.S. Application Data
(60) Provisional application No. 63/648,196, filed on May 16, 2024.

(51) Int. Cl. F21V 8/00

(52) U.S. Cl. CPC G02B 6/0016; G02B 6/0036; G02B 6/0088

(57) ABSTRACT

A waveguide device includes at least one light-transmitting substrate, a first image coupling-in element, a first image coupling-out element, a second image coupling-in element, and a second image coupling-out element. The light-transmitting substrate includes a central region and a peripheral region surrounding the central region. The first image coupling-in element is located in the peripheral region and is configured to diffract a first light beam into the light-transmitting substrate. The first image coupling-out element is located in the central region and is configured to diffract the diffracted first light beam propagating in the light-transmitting substrate. The second image coupling-in element is located in the peripheral region and is configured to diffract a second light beam into the light-transmitting substrate. The second image coupling-out element is located in the central region and is configured to diffract the diffracted second light beam propagating in the light-transmitting substrate.

### CROSS-REFERENCE TO RELATED APPLICATION

This application claims priority to U.S. Provisional Application Ser. No. 63/648,196, filed on May 16, 2024, which is herein incorporated by reference.

### BACKGROUND

### Technical Field

The present disclosure relates to a waveguide device and an optical device using the same.

### Description of Related Art

Various types of computing, entertainment, and/or mobile devices can be implemented with a transparent or semi-transparent display through which a user of a device can view the surrounding environment. Such devices, which can be referred to as see-through, mixed reality display device systems, or as augmented reality (AR) systems, enable a user to see through the transparent or semi-transparent display of a device to view the surrounding environment, and also see images of virtual objects (e.g., text, graphics, video, etc.) that are generated for display to appear as a part of, and/or overlaid upon, the surrounding environment. These devices, which can be implemented as head-mounted display (HMD) glasses or other wearable display devices, but are not limited thereto, often utilize optical waveguides to replicate an image to a location where a user of a device can view the image as a virtual image in an augmented reality environment. As this is still an emerging technology, there are certain challenges associated with utilizing waveguides to display images of virtual objects to a user.

However, reviewing the existing augmented reality display devices on the market, their core architecture is mostly based on a single set of image guiding units and operates in a one-to-one image-input and image-output mode. Such designs tend to provide only a single and fixed virtual image presentation effect at any given time, making it difficult to perform real-time and flexible adjustments to key parameters such as the position, virtual image distance, and field of view of the virtual image viewed by the user. In other words, the current technical level is still insufficient in providing users with a diverse and dynamically adjustable virtual image experience.

Accordingly, it is an important issue for the industry to provide a waveguide device and an optical device using the same that are capable of solving the aforementioned problems.

### SUMMARY

An aspect of the disclosure is to provide a waveguide device and an optical device using the same that can efficiently solve the aforementioned problems.

According to an embodiment of the disclosure, a waveguide device includes at least one light-transmitting substrate, a first image coupling-in element, a first image coupling-out element, a second image coupling-in element, and a second image coupling-out element. The at least one light-transmitting substrate includes a central region and a peripheral region surrounding the central region. The first image coupling-in element is located in the peripheral region and is configured to diffract a first light beam to propagate in the at least one light-transmitting substrate. The first image coupling-out element is located in the central region and is configured to diffract the diffracted first light beam propagating in the at least one light-transmitting substrate. The second image coupling-in element is located in the peripheral region and is configured to diffract a second light beam to propagate in the at least one light-transmitting substrate. The second image coupling-out element is located in the central region and is configured to diffract the diffracted second light beam propagating in the at least one light-transmitting substrate.

In an embodiment of the disclosure, the first image coupling-in element and the first image coupling-out element are aligned radially. The second image coupling-in element and the second image coupling-out element are aligned radially.

In an embodiment of the disclosure, the first light beam and the second light beam have an identical wavelength.

In an embodiment of the disclosure, the first image coupling-out element is configured to diffract the diffracted first light beam to propagate with a first diffraction angle. The second image coupling-out element is configured to diffract the diffracted second light beam to propagate with a second diffraction angle different from the first diffraction angle.

In an embodiment of the disclosure, the first image coupling-out element conforms to a first diffraction wave function. The second image coupling-out element conforms to a second diffraction wave function different from the first diffraction wave function.

In an embodiment of the disclosure, the first diffraction wave function is a wave function of a first distance of virtual image. The second diffraction wave function is a wave function of a second distance of virtual image different from the first distance of virtual image.

In an embodiment of the disclosure, the first diffraction wave function is a wave function of a first field of view of virtual image. The second diffraction wave function is a wave function of a second field of view of virtual image different from the first field of view of virtual image.

In an embodiment of the disclosure, the first image coupling-out element includes a first diffraction grating. The second image coupling-out element includes a second diffraction grating. The first diffraction grating and the second diffraction grating intersect each other.

In an embodiment of the disclosure, the at least one light-transmitting substrate includes a first light-transmitting substrate and a second light-transmitting substrate. The first image coupling-in element and the first image coupling-out element are located on the first light-transmitting substrate. The second image coupling-in element and the second image coupling-out element are located on the second light-transmitting substrate.

In an embodiment of the disclosure, the first light beam and the second light beam have different wavelengths.

In an embodiment of the disclosure, the first light beam and the second light beam have an identical wavelength.

In an embodiment of the disclosure, the central region is rotatably connected to the peripheral region.

According to an embodiment of the disclosure, an optical device includes a housing, a waveguide device, and a projector. The waveguide device includes at least one light-transmitting substrate, a first image coupling-in element, a first image coupling-out element, a second image coupling-in element, and a second image coupling-out element. The at least one light-transmitting substrate is rotatably connected to the housing and includes a central region and a peripheral region surrounding the central region. The first image coupling-in element is located in the peripheral region and is configured to diffract a first light beam to propagate in the at least one light-transmitting substrate. The first image coupling-out element is located in the central region and is configured to diffract the diffracted first light beam propagating in the at least one light-transmitting substrate. The second image coupling-in element is located in the peripheral region and is configured to diffract a second light beam to propagate in the at least one light-transmitting substrate. The second image coupling-out element is located in the central region and is configured to diffract the diffracted second light beam propagating in the at least one light-transmitting substrate. The projector is disposed on the housing and is configured to emit the first light beam and the second light beam toward the peripheral region along an optical path.

In an embodiment of the disclosure, the first light beam and the second light beam have an identical wavelength.

In an embodiment of the disclosure, the first image coupling-out element is configured to diffract the diffracted first light beam to propagate with a first diffraction angle. The second image coupling-out element is configured to diffract the diffracted second light beam to propagate with a second diffraction angle different from the first diffraction angle.

In an embodiment of the disclosure, the first image coupling-out element conforms to a first diffraction wave function. The second image coupling-out element conforms to a second diffraction wave function different from the first diffraction wave function.

In an embodiment of the disclosure, the first diffraction wave function is a wave function of a first distance of virtual image. The second diffraction wave function is a wave function of a second distance of virtual image different from the first distance of virtual image.

In an embodiment of the disclosure, the first diffraction wave function is a wave function of a first field of view of virtual image. The second diffraction wave function is a wave function of a second field of view of virtual image different from the first field of view of virtual image.

In an embodiment of the disclosure, the first image coupling-out element comprises a first diffraction grating. The second image coupling-out element comprises a second diffraction grating. The first diffraction grating and the second diffraction grating intersect each other.

In an embodiment of the disclosure, the central region is rotatably connected to the peripheral region.

Accordingly, in the waveguide device and optical device using the same of the present disclosure, by locating a plurality of image coupling-in elements in the peripheral region of the light-transmitting substrate and correspondingly locating a plurality of image coupling-out elements in the central region of the light-transmitting substrate, independent light guiding and output control of a plurality of light beams can be achieved. In this way, the waveguide device and optical device of the present disclosure can effectively solve the bottlenecks encountered in the prior art, such as potential limitations in position, distance of virtual image, or field of view of virtual image, thereby providing a more flexible and diversified virtual image presentation effect.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic view of an optical device according to an embodiment of the present disclosure;

FIG. 2 is a front view of one of waveguide devices in FIG. 1;

FIG. 3A is a partial schematic view of the waveguide device in FIG. 2;

FIG. 3B is another partial schematic view of the waveguide device in FIG. 2;

FIG. 3C is another partial schematic view of the waveguide device in FIG. 2;

FIG. 3D is another partial schematic view of the waveguide device in FIG. 2;

FIG. 4 is a schematic diagram of different positions of virtual image;

FIG. 5 is a partial schematic view of a first image coupling-in element in FIG. 3A;

FIG. 6 is a schematic view of an optical exposure system for manufacturing a diffractive element;

FIG. 7 is a partial schematic view of a light-transmitting substrate with a first image coupling-in element thereon according to another embodiment of the present disclosure;

FIG. 8 is a partial schematic view of a first image coupling-in element according to another embodiment of the present disclosure;

FIG. 9A is a partial schematic view of a waveguide device according to another embodiment of the present disclosure;

FIG. 9B is another partial schematic view of the waveguide device in FIG. 9A;

FIG. 9C is another partial schematic view of the waveguide device in FIG. 9A;

FIG. 9D is another partial schematic view of the waveguide device in FIG. 9A;

FIG. 10 is a schematic diagram of different distances of virtual image;

FIG. 11A is a partial schematic view of a waveguide device according to another embodiment of the present disclosure;

FIG. 11B is another partial schematic view of the waveguide device in FIG. 11A;

FIG. 11C is another partial schematic view of the waveguide device in FIG. 11A;

FIG. 11D is another partial schematic view of the waveguide device in FIG. 11A;

FIG. 12 is a schematic diagram of different fields of view of virtual image;

FIG. 13 is a front view of a waveguide device according to another embodiment of the present disclosure;

FIG. 14 is a front view of a waveguide device according to another embodiment of the present disclosure;

FIG. 15 is a front view of a waveguide device according to another embodiment of the present disclosure; and

FIG. 16 is a front view of a waveguide device according to another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

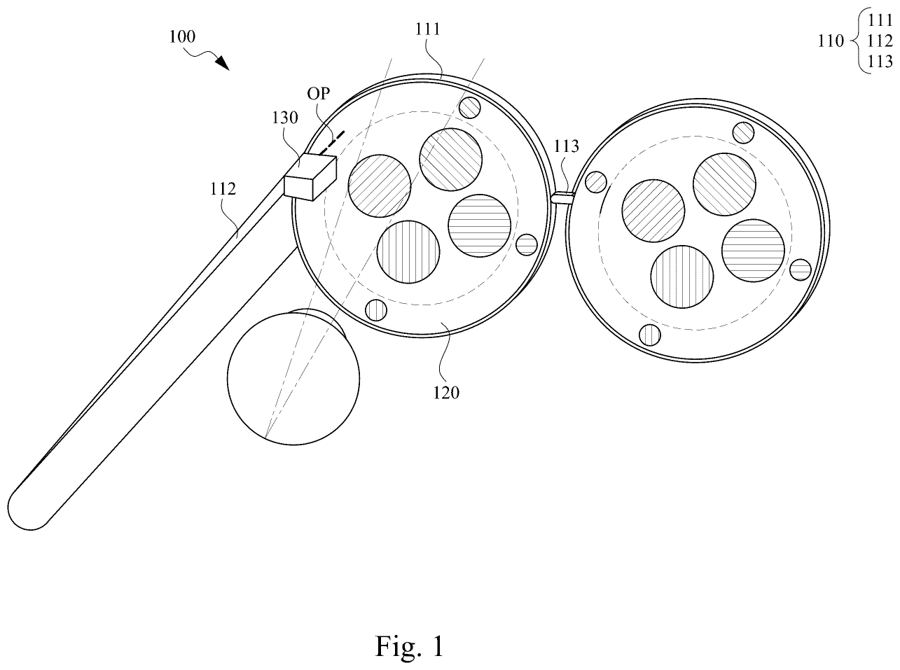

Reference is made to FIG. 1. FIG. 1 is a schematic view of an optical device 100 according to an embodiment of the present disclosure. As shown in FIG. 1, in the present embodiment, the optical device 100 may be used in an augmented reality device which can be implemented as, but is not limited thereto, a pair of glasses or other wearable display devices. Specifically, the optical device 100 includes a housing 110, two waveguide devices 120, and a projector 130. The housing 110 includes two frames 111, a temple 112, and a connecting member 113. The waveguide devices 120 are rotatably connected to inner edges of the frames 111, respectively. The temple 112 is connected to an edge of one of the waveguide devices 120. The connecting member 113 is connected between the frames 111. The projector 130 is disposed on a side of the temple 112 adjacent to the one of waveguide devices 120. The optical device 100 may include another temple 112 (not shown) connected to an edge of another of the waveguide devices 120. The primary function of each of the waveguide devices 120 is to superimpose a virtual image generated by the projector 130 onto the real world scene viewed through the waveguide devices 120 by the user.

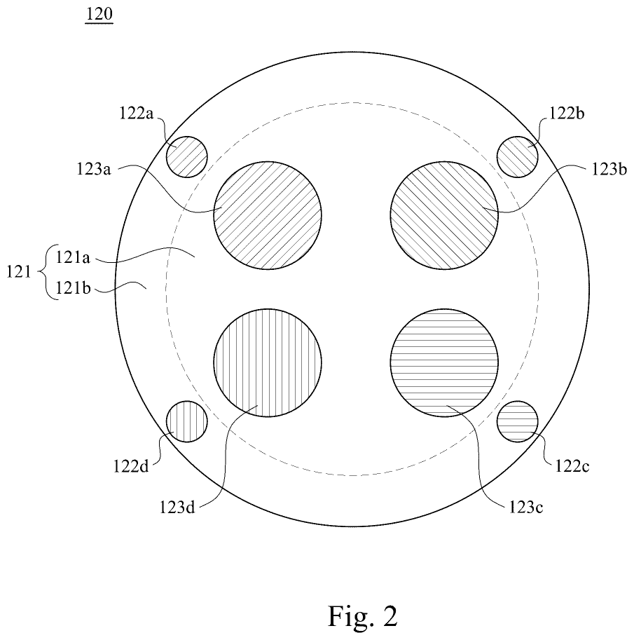

Reference is made to FIG. 2. FIG. 2 is a front view of one of the waveguide devices 120 in FIG. 1. As shown in FIGS. 1 and 2, in the present embodiment, the waveguide device 120 includes a light-transmitting substrate 121, a first image coupling-in element 122a, a first image coupling-out element 123a, a second image coupling-in element 122b, a second image coupling-out element 123b, a third image coupling-in element 122c, a third image coupling-out element 123c, a fourth image coupling-in element 122d, and a fourth image coupling-out element 123d. The light-transmitting substrate 121 is rotatably connected to the inner edge of one of the frames 111 of the housing 110. The light-transmitting substrate 121 includes a central region 121a and a peripheral region 121b surrounding the central region 121a. The first image coupling-in element 122a, the second image coupling-in element 122b, the third image coupling-in element 122c, and the fourth image coupling-in element 122d are located in the peripheral region 121b. The first image coupling-out element 123a, the second image coupling-out element 123b, the third image coupling-out element 123c, and the fourth image coupling-out element 123d are located in the central region 121a. Specifically, the first image coupling-in element 122a and the first image coupling-out element 123a are aligned radially. The second image coupling-in element 122b and the second image coupling-out element 123b are aligned radially. The third image coupling-in element 122c and the third image coupling-out element 123c are aligned radially. The fourth image coupling-in element 122d and the fourth image coupling-out element 123d are aligned radially. That is, a combination of the first image coupling-in element 122a and the first image coupling-out element 123a, a combination of the second image coupling-in element 122b and the second image coupling-out element 123b, a combination of the third image coupling-in element 122c and the third image coupling-out element 123c, and a combination of the fourth image coupling-in element 122d and the fourth image coupling-out element 123d are arranged in a radial manner.

As shown in FIG. 1 with reference to FIG. 2, in the present embodiment, the projector 130 is configured to emit light toward the peripheral region 121b along an optical path OP. In this way, when the light-transmitting substrate 121 rotates counterclockwise relative to the frame 111 of the housing 110, the light emitted by the projector 130 is sequentially incident on the first image coupling-in element 122a, the second image coupling-in element 122b, the third image coupling-in element 122c, and the fourth image coupling-in element 122d.

In some embodiments, the central region 121a is rotatably connected to the peripheral region 121b. For example, the central region 121a is stationary to the frame 111 of the housing 110, and the peripheral region 121b is capable of rotating between the frame 111 and the central region 121a. In some embodiments, to solve a refraction problem at the interface between the central region 121a and the peripheral region 121b, a material with a matching refractive index may be used to fill the interface.

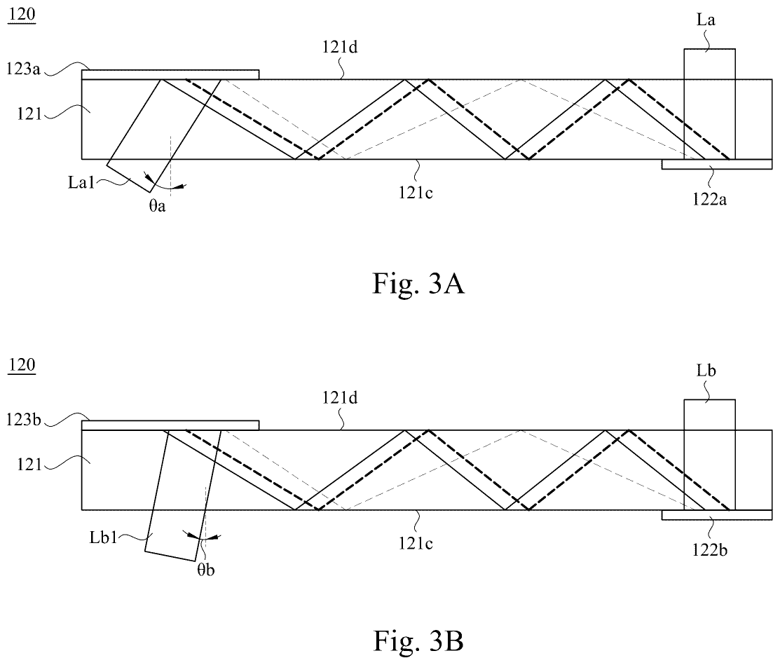

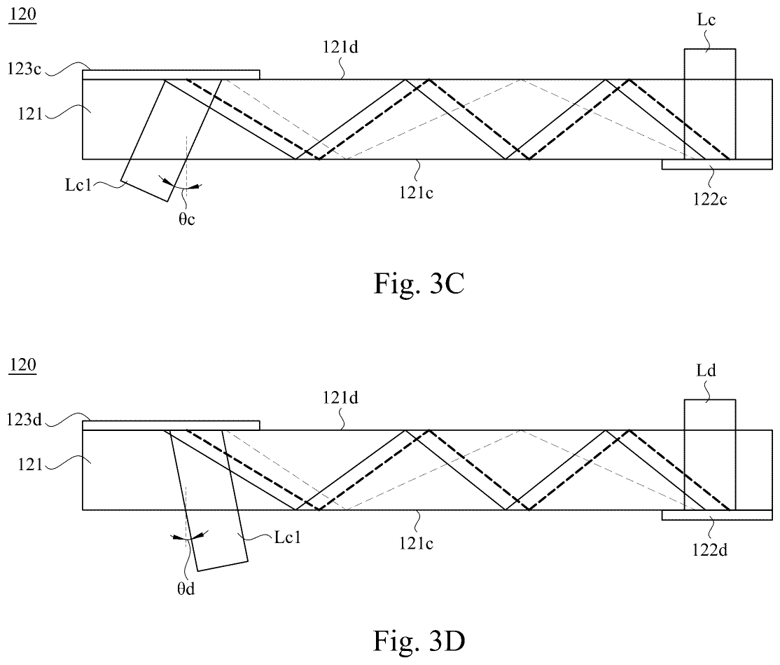

Reference is made to FIG. 3A. FIG. 3A is a partial schematic view of the waveguide device 120 in FIG. 2. As shown in FIG. 3A, in the present embodiment, the light-transmitting substrate 121 has a first surface 121c and a second surface 121d opposite to each other. The first image coupling-in element 122a is disposed on the first surface 121c and is configured to diffract a first light beam La to propagate in the light-transmitting substrate 121. Specifically, the first light beam La is a parallel beam of light. The first light beam La enters the light-transmitting substrate 121 from the second surface 121d and is incident vertically on the first image coupling-in element 122a disposed on the first surface 121c. On the other hand, the first image coupling-out element 123a is disposed on the second surface 121d and is configured to diffract the diffracted first light beam La propagating in the light-transmitting substrate 121 into a first output light beam La1. Specifically, the first output light beam La1 leaves the light-transmitting substrate 121 from the first surface 121c.

Reference is made to FIG. 3B. FIG. 3B is another partial schematic view of the waveguide device 120 in FIG. 2. As shown in FIG. 3B, in the present embodiment, the second image coupling-in element 122b is disposed on the first surface 121c and is configured to diffract a second light beam Lb to propagate in the light-transmitting substrate 121. Specifically, the second light beam Lb is a parallel beam of light. The second light beam Lb enters the light-transmitting substrate 121 from the second surface 121d and is incident vertically on the second image coupling-in element 122b disposed on the first surface 121c. On the other hand, the second image coupling-out element 123b is disposed on the second surface 121d and is configured to diffract the diffracted second light beam Lb propagating in the light-transmitting substrate 121 into a second output light beam Lb1. Specifically, the second output light beam Lb1 leaves the light-transmitting substrate 121 from the first surface 121c.

Reference is made to FIG. 3C. FIG. 3C is another partial schematic view of the waveguide device 120 in FIG. 2. As shown in FIG. 3C, in the present embodiment, the third image coupling-in element 122c is disposed on the first surface 121c and is configured to diffract a third light beam Lc to propagate in the light-transmitting substrate 121. Specifically, the third light beam Lc is a parallel beam of light. The third light beam Lc enters the light-transmitting substrate 121 from the second surface 121d and is incident vertically on the third image coupling-in element 122c disposed on the first surface 121c. On the other hand, the third image coupling-out element 123c is disposed on the second surface 121d and is configured to diffract the diffracted third light beam Lc propagating in the light-transmitting substrate 121 into a third output light beam Lc1. Specifically, the third output light beam Lc1 leaves the light-transmitting substrate 121 from the first surface 121c.

Reference is made to FIG. 3D. FIG. 3D is another partial schematic view of the waveguide device 120 in FIG. 2. As shown in FIG. 3D, in the present embodiment, the fourth image coupling-in element 122d is disposed on the first surface 121c and is configured to diffract a fourth light beam Ld to propagate in the light-transmitting substrate 121. Specifically, the fourth light beam Ld is a parallel beam of light. The fourth light beam Ld enters the light-transmitting substrate 121 from the second surface 121d and is incident vertically on the fourth image coupling-in element 122d disposed on the first surface 121c. On the other hand, the fourth image coupling-out element 123d is disposed on the second surface 121d and is configured to diffract the diffracted fourth light beam Ld propagating in the light-transmitting substrate 121 into a fourth output light beam Ld1. Specifically, the fourth output light beam Ld1 leaves the light-transmitting substrate 121 from the first surface 121c.

As shown in FIGS. 3A to 3D, it can be seen that the diffraction angle with which the first image coupling-out element 123a diffracts the diffracted first light beam La to propagate, the diffraction angle with which the second image coupling-out element 123b diffracts the diffracted second light beam Lb to propagate, the diffraction angle with which the third image coupling-out element 123c diffracts the diffracted third light beam Lc to propagate, and the diffraction angle with which the fourth image coupling-out element 123d diffracts the diffracted fourth light beam Ld to propagate are different from each other. In this way, a first exit angle θa of the first output light beam La1 at the first surface 121c, a second exit angle θb of the second output light beam Lb1 at the first surface 121c, a third exit angle θc of the third output light beam Lc1 at the first surface 121c, and a fourth exit angle θd of the fourth output light beam Ld1 at the first surface 121c are different from each other.

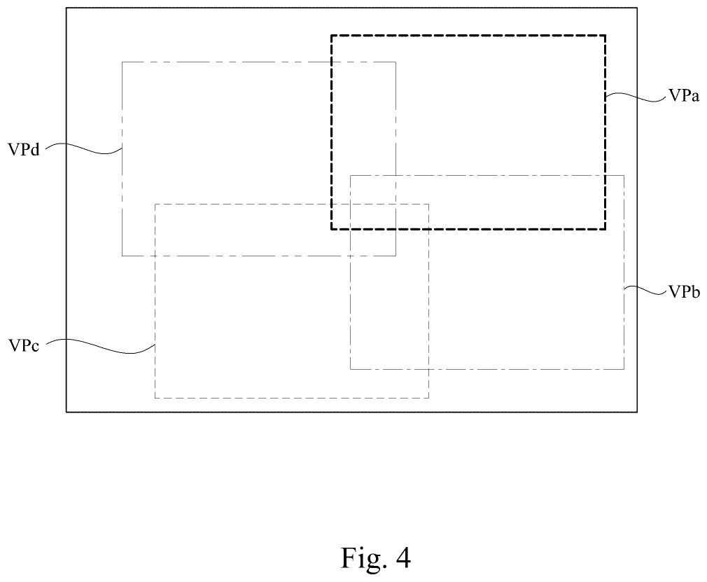

Reference is made to FIG. 4. FIG. 4 is a schematic diagram of different positions of virtual image VPa, VPb, VPc, VPd. As shown in FIGS. 3A and 4, the virtual image presented by the first output light beam La1 will correspond to the position of virtual image VPa in FIG. 4 viewed by an eye of the user. As shown in FIGS. 3B and 4, the virtual image presented by the second output light beam Lb1 will correspond to the position of virtual image VPb in FIG. 4 viewed by the eye of the user. As shown in FIGS. 3C and 4, the virtual image presented by the third output light beam Lc1 will correspond to the position of virtual image VPc in FIG. 4 viewed by the eye of the user. As shown in FIGS. 3D and 4, the virtual image presented by the fourth output light beam Ld1 will correspond to the position of virtual image VPd in FIG. 4 viewed by the eye of the user.

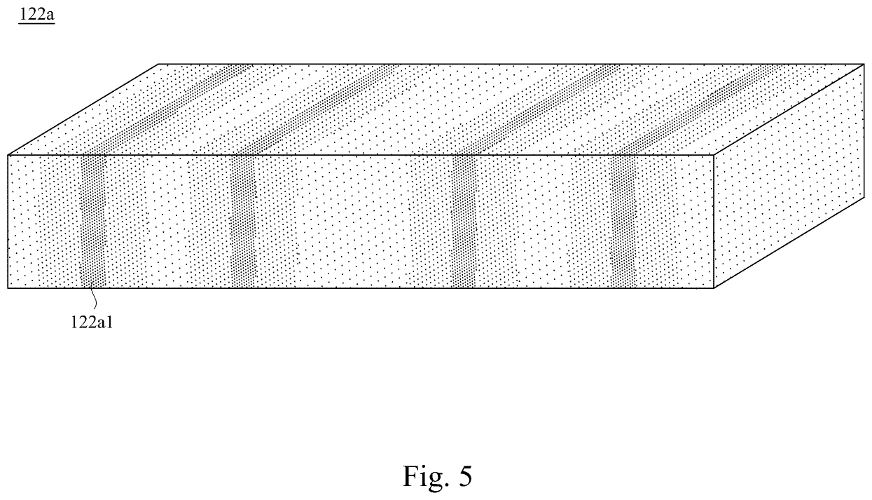

Reference is made to FIG. 5. FIG. 5 is a partial schematic view of the first image coupling-in element 122a in FIG. 3A. As shown in FIG. 5, in the present embodiment, the first image coupling-in element 122a includes at least one holographic grating 122a1. The holographic grating 122a1 is configured to diffract the light (i.e., the first light beam La) incident on the first image coupling-in element 122a. The holographic grating 122a1 of the first image coupling-in element 122a is a reflective holographic grating, but the present disclosure is not limited thereto. In some other embodiments, the holographic grating 122a1 of the first image coupling-in element 122a may be a transmissive holographic grating, and the first image coupling-in element 122a may be disposed on the second surface 121d of the light-transmitting substrate 121. The holographic grating 122a1 is a volume holographic grating. It is notable that light diffracted by a volume holographic grating can propagate based on the Bragg's law.

In some embodiments, the second image coupling-in element 122b may include at least one holographic grating configured to diffract the light (i.e., the second light beam Lb) incident on the second image coupling-in element 122b. In some embodiments, the third image coupling-in element 122c may include at least one holographic grating configured to diffract the light (i.e., the third light beam Lc) incident on the third image coupling-in element 122c. In some embodiments, the fourth image coupling-in element 122d may include at least one holographic grating configured to diffract the light (i.e., the fourth light beam Ld) incident on the fourth image coupling-in element 122d.

As shown in FIGS. 3B to 3D, in the present embodiment, the holographic gratings of the second image coupling-in element 122b, the third image coupling-in element 122c, and the fourth image coupling-in element 122d are reflective holographic gratings, but the present disclosure is not limited thereto. In some other embodiments, the holographic grating of at least one of the second image coupling-in element 122b, the third image coupling-in element 122c, and the fourth image coupling-in element 122d may be a transmissive holographic grating, and the at least one of the second image coupling-in element 122b, the third image coupling-in element 122c, and the fourth image coupling-in element 122d may be disposed on the second surface 121d of the light-transmitting substrate 121.

As shown in FIGS. 3A to 3D, in the present embodiment, the first image coupling-out element 123a may include at least one holographic grating configured to diffract the light (i.e., the first light beam La) propagating in the light-transmitting substrate 121, the second image coupling-out element 123b may include at least one holographic grating configured to diffract the light (i.e., the second light beam Lb) propagating in the light-transmitting substrate 121, the third image coupling-out element 123c may include at least one holographic grating configured to diffract the light (i.e., the third light beam Lc) propagating in the light-transmitting substrate 121, and the fourth image coupling-out element 123d may include at least one holographic grating configured to diffract the light (i.e., the fourth light beam Ld) propagating in the light-transmitting substrate 121. The holographic gratings of the first image coupling-out element 123a, the second image coupling-out element 123b, the third image coupling-out element 123c, and the fourth image coupling-out element 123d are reflective holographic gratings, but the present disclosure is not limited thereto. In some other embodiments, the holographic grating of at least one of the first image coupling-out element 123a, the second image coupling-out element 123b, the third image coupling-out element 123c, and the fourth image coupling-out element 123d may be a transmissive holographic grating, and the at least one of the first image coupling-out element 123a, the second image coupling-out element 123b, the third image coupling-out element 123c, and the fourth image coupling-out element 123d may be disposed on the first surface 121c of the light-transmitting substrate 121.

In some embodiments, the first light beam La, the second light beam Lb, the third light beam Lc, and the fourth light beam Ld emitted by the projector 130 may have an identical wavelength, but the present disclosure is not limited thereto.

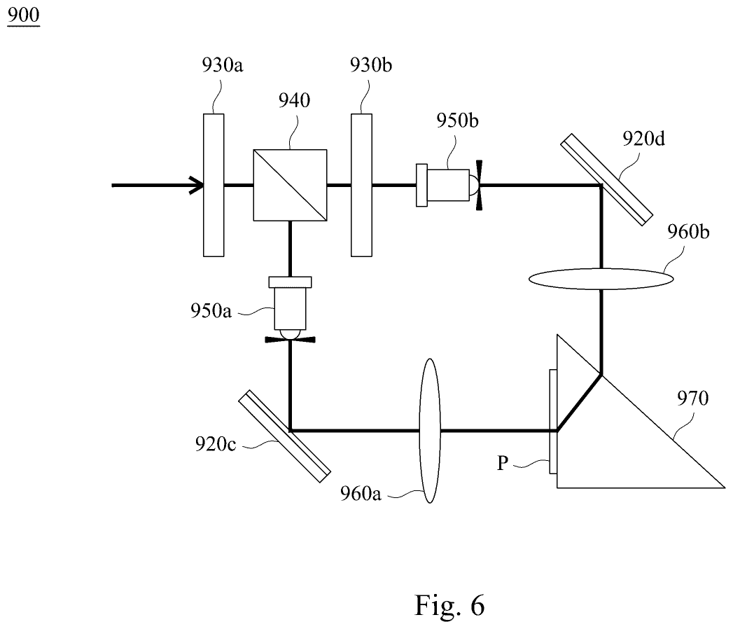

Reference is made to FIG. 6. FIG. 6 is a schematic view of an optical exposure system 900 for manufacturing a holographic optical element. As shown in FIG. 6, the optical exposure system 900 includes two mirrors 920c, 920d, two half-wave plates 930a, 930b, a polarizing beam splitter 940, two spatial filters 950a, 950b, two lenses 960a, 960b, and a prism 970. A photopolymer P is attached to a side of the prism 970. The optical exposure system 900 is configured to expose a portion of the photopolymer P with two light beams in difference incidence directions from opposite sides of the photopolymer P. The photopolymer P includes monomer, polymer, photo-initiator, and binder. When the photopolymer P is subjected to an exposure process, the photo-initiator receives photons to generate radicals, so that the monomers begin to polymerize (i.e., photopolymerization). By using the exposure method of hologram interference fringe, the monomer that is not illuminated by the light (i.e., in dark zone) is diffused to the light irradiation zone (i.e., bright zone) and polymerized, thereby causing a non-uniform concentration gradient of the polymer. And finally, after fixing, phase gratings each including bright and dark stripes arranged in a staggered manner can be formed, and the photopolymer P is transformed to the holographic optical element.

In some embodiments, at least one of the first image coupling-in element 122a, the second image coupling-in element 122b, the third image coupling-in element 122c, the fourth image coupling-in element 122d, the first image coupling-out element 123a, the second image coupling-out element 123b, the third image coupling-out element 123c, and the fourth image coupling-out element 123d may be manufactured by the optical exposure system 900 shown in FIG. 6.

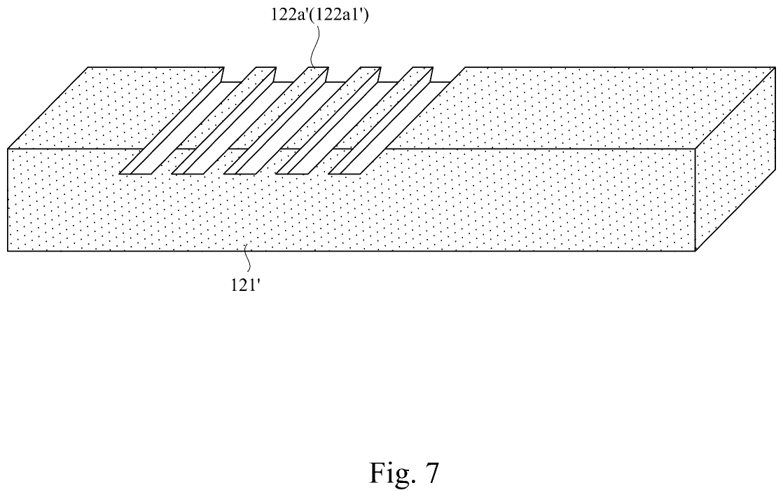

Reference is made to FIG. 7. FIG. 7 is a partial schematic view of a light-transmitting substrate 121′ with a first image coupling-in element 122a′ thereon according to another embodiment of the present disclosure. As shown in FIG. 7, in the present embodiment, the first image coupling-in element 122a′ formed on a surface of the light-transmitting substrate 121′ includes a plurality of surface structures 122a1′. The first image coupling-in element 122a′ uses the surface structures 122a1′ to form width periodic structures. The surface structures 122a1′ may be manufactured to form a surface relief diffraction grating, and the surface relief diffraction grating may form a holographic grating. In this way, the diffraction characteristics of the holographic grating of the first image coupling-in element 122a′ formed by the surface relief diffraction grating may be identical or similar to the diffraction characteristics of the holographic grating of the first image coupling-in element 122a formed by the volume holographic grating.

In some embodiments, at least one of the second image coupling-in element 122b, the third image coupling-in element 122c, the fourth image coupling-in element 122d, the first image coupling-out element 123a, the second image coupling-out element 123b, the third image coupling-out element 123c, and the fourth image coupling-out element 123d may include a plurality of surface structures forming a surface relief diffraction grating just as the first image coupling-in element 122a′ does.

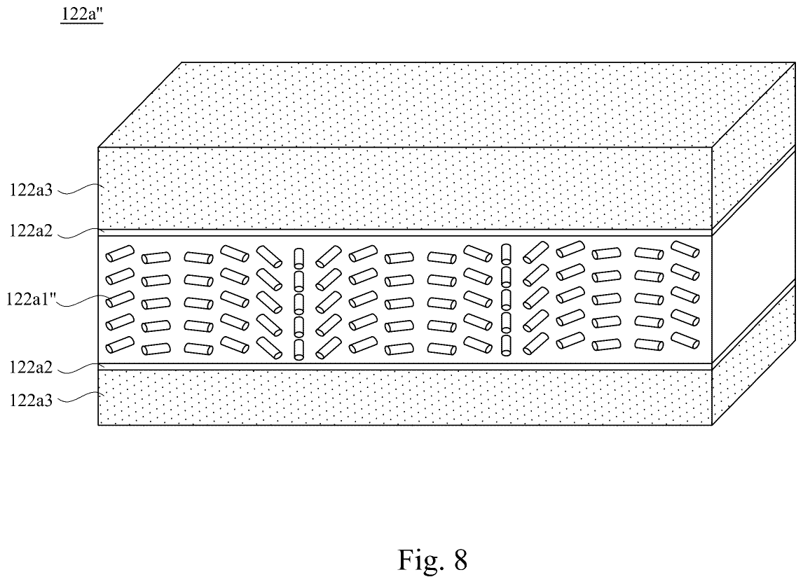

Reference is made to FIG. 8. FIG. 8 is a partial schematic view of a first image coupling-in element 122a″ according to another embodiment of the present disclosure. As shown in FIG. 8, in the present embodiment, the first image coupling-in element 122a″ includes a plurality of liquid crystal molecules 122a1″ disposed between two photo-alignment layers 122a2, and the photo-alignment layers 122a2 are sandwiched between two light-transmitting substrates 122a3. A voltage may be applied to the photo-alignment layers 122a2 to rotate the liquid crystal molecules 122a1″ to form width periodic structures. In other words, the first image coupling-in element 122a″ uses the internal liquid crystal molecules 122a1″ to form width periodic structures, so outer surfaces of the light-transmitting substrates 122a3 have no solid structure. The rotated liquid crystal molecules 122a1″ may form a liquid crystal grating, and the liquid crystal grating may form a holographic grating. In this way, the diffraction characteristics of the holographic grating of the first image coupling-in element 122a″ formed by the liquid crystal grating may be identical or similar to the diffraction characteristics of the holographic grating of the first image coupling-in element 122a formed by the volume holographic grating.

In some embodiments, at least one of the second image coupling-in element 122b, the third image coupling-in element 122c, the fourth image coupling-in element 122d, the first image coupling-out element 123a, the second image coupling-out element 123b, the third image coupling-out element 123c, and the fourth image coupling-out element 123d may include a liquid crystal grating just as the first image coupling-in element 122a″ does.

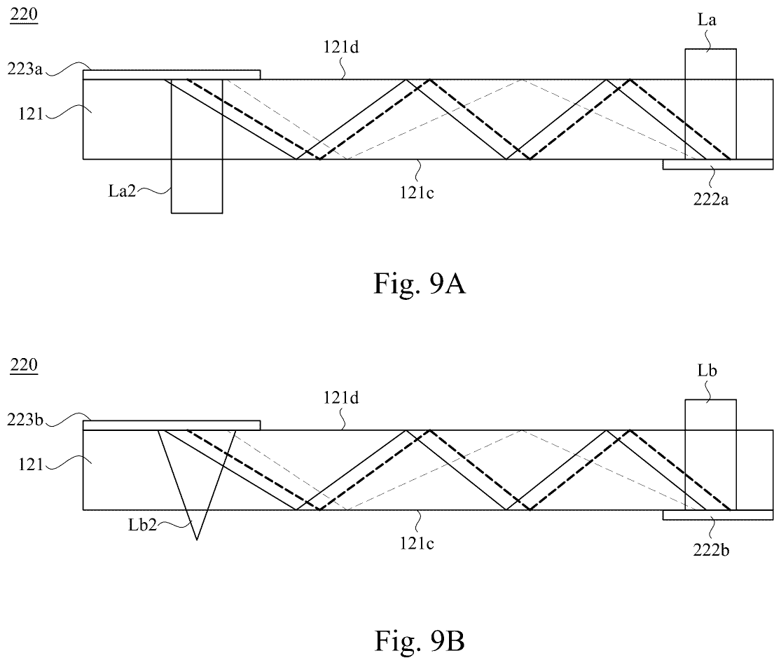

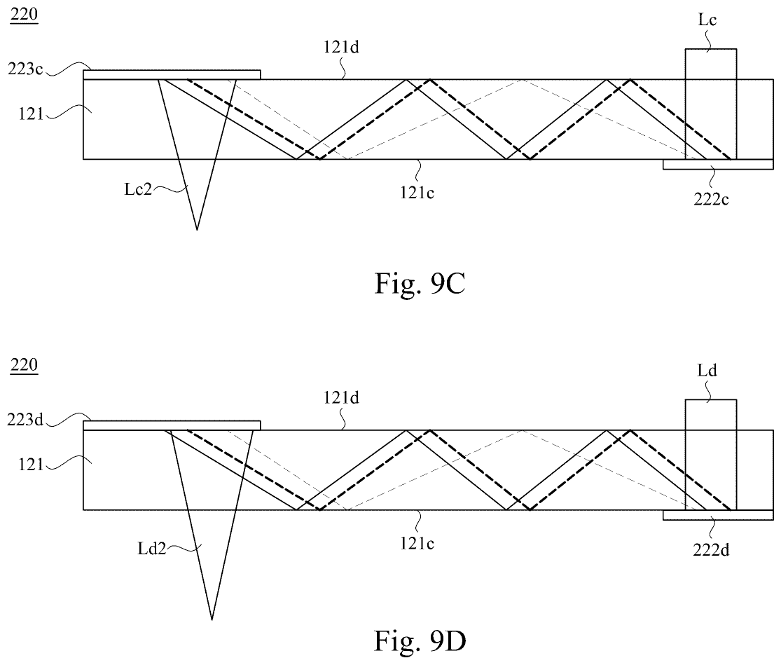

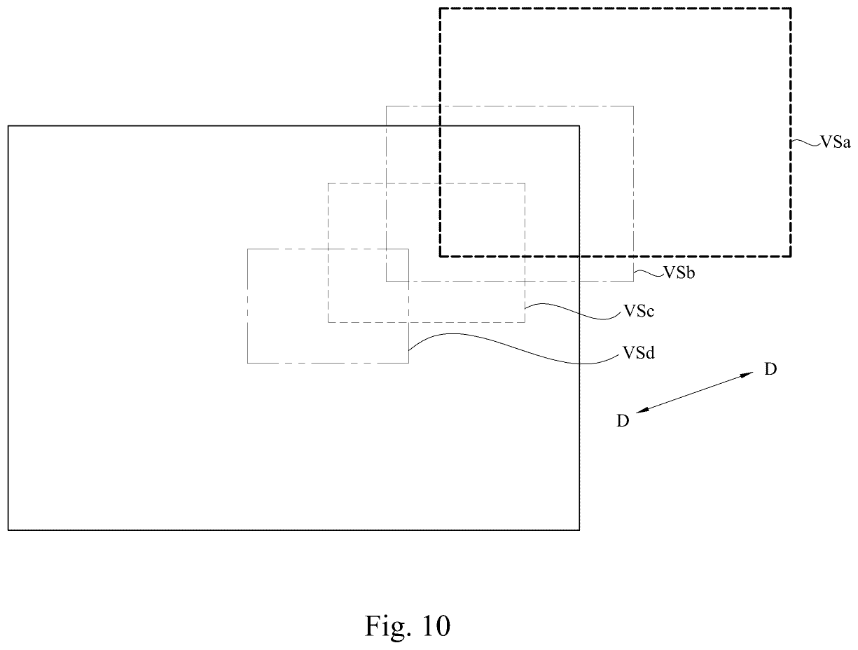

Reference is made to FIGS. 9A to 9D. FIGS. 9A to 9D respectively are different partial schematic views of a waveguide device 220 according to another embodiment of the present disclosure. As shown in FIGS. 9A to 9D, in the present embodiment, the waveguide device 220 includes a light-transmitting substrate 121, a first image coupling-in element 222a, a second image coupling-in element 222b, a third image coupling-in element 222c, a fourth image coupling-in element 222d, a first image coupling-out element 223a, a second image coupling-out element 223b, a third image coupling-out element 223c, and a fourth image coupling-out element 223d. The relative positions of these components of the waveguide device 220 are identical to those of the waveguide device 120 as shown in FIGS. 2 to 3D. The functions of the first image coupling-in element 222a, the second image coupling-in element 222b, the third image coupling-in element 222c, the fourth image coupling-in element 222d are identical to those of the waveguide device 120. The functions of the first image coupling-out element 223a, the second image coupling-out element 223b, the third image coupling-out element 223c, the fourth image coupling-out element 223d are similar to those of the waveguide device 120.

Specifically, the first image coupling-out element 223a is configured to diffract the diffracted first light beam La propagating in the light-transmitting substrate 121 into a first output light beam La2. The second image coupling-out element 223b is configured to diffract the diffracted second light beam Lb propagating in the light-transmitting substrate 121 into a second output light beam Lb2. The third image coupling-out element 223c is configured to diffract the diffracted third light beam Lc propagating in the light-transmitting substrate 121 into a third output light beam Lc2. The fourth image coupling-out element 223d is configured to diffract the diffracted fourth light beam Ld propagating in the light-transmitting substrate 121 into a fourth output light beam Ld2.

It should be pointed out that the first image coupling-out element 223a conforms to a first diffraction wave function, the second image coupling-out element 223b conforms to a second diffraction wave function, the third image coupling-out element 223c conforms to a third diffraction wave function, and the fourth image coupling-out element 223d conforms to a fourth diffraction wave function. The first diffraction wave function, the second diffraction wave function, the third diffraction wave function, and the fourth diffraction wave function are different from each other. The first diffraction wave function, the second diffraction wave function, the third diffraction wave function, and the fourth diffraction wave function are wave functions of different distances of virtual image, respectively.

Reference is made to FIG. 10. FIG. 10 is a schematic diagram of different distances of virtual image. As shown in FIGS. 9A and 10, the virtual image presented by the first output light beam La2 will correspond to a first distance of virtual image VSa in FIG. 10 viewed by the eye of the user along a direction D. As shown in FIGS. 9B and 10, the virtual image presented by the second output light beam Lb2 will correspond to a second distance of virtual image VSb in FIG. 10 viewed by the eye of the user along the direction D. As shown in FIGS. 9C and 10, the virtual image presented by the third output light beam Lc2 will correspond to a third distance of virtual image VSc in FIG. 10 viewed by the eye of the user along the direction D. As shown in FIGS. 9D and 10, the virtual image presented by the fourth output light beam Ld2 will correspond to a fourth distance of virtual image VSd in FIG. 10 viewed by the eye of the user along the direction D. For example, the first distance of virtual image VSa of the first diffraction wave function is infinite, the second distance of virtual image VSb of the second diffraction wave function is about 3 m, the third distance of virtual image VSc of the third diffraction wave function is about 1 m, and the fourth distance of virtual image VSd of the fourth diffraction wave function is about 0.5 m, but the present disclosure is not limited thereto.

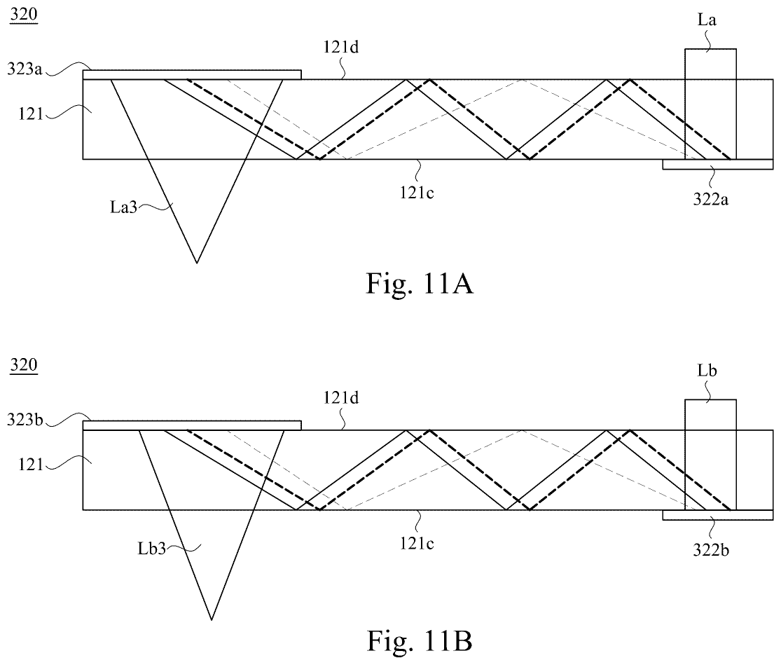

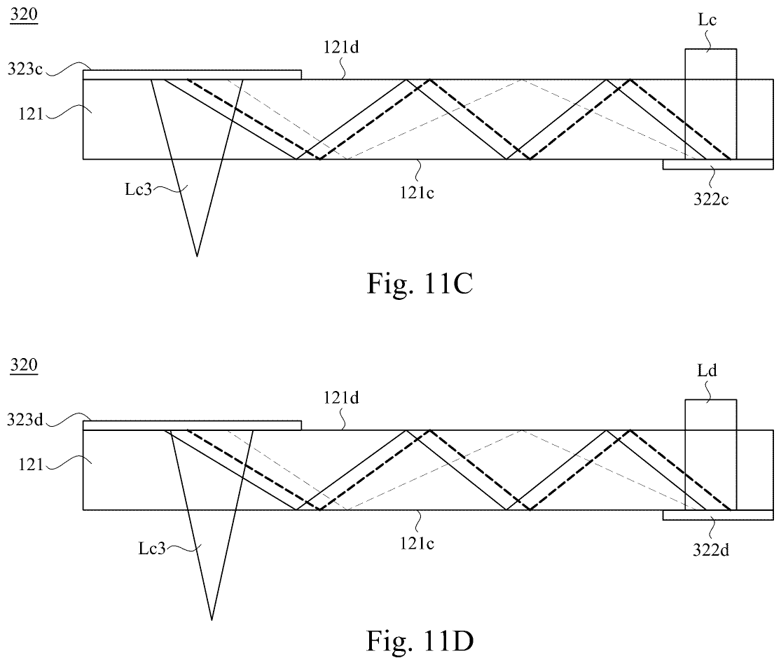

Reference is made to FIGS. 11A to 11D. FIGS. 11A to 11D respectively are different partial schematic views of a waveguide device 320 according to another embodiment of the present disclosure. As shown in FIGS. 11A to 11D, in the present embodiment, the waveguide device 320 includes a light-transmitting substrate 121, a first image coupling-in element 322a, a second image coupling-in element 322b, a third image coupling-in element 322c, a fourth image coupling-in element 322d, a first image coupling-out element 323a, a second image coupling-out element 323b, a third image coupling-out element 323c, and a fourth image coupling-out element 323d. The relative positions of these components of the waveguide device 320 are identical to those of the waveguide device 120 as shown in FIGS. 2 to 3D. The functions of the first image coupling-in element 322a, the second image coupling-in element 322b, the third image coupling-in element 322c, the fourth image coupling-in element 322d are identical to those of the waveguide device 120. The functions of the first image coupling-out element 323a, the second image coupling-out element 323b, the third image coupling-out element 323c, the fourth image coupling-out element 323d are similar to those of the waveguide device 120.

Specifically, the first image coupling-out element 323a is configured to diffract the diffracted first light beam La propagating in the light-transmitting substrate 121 into a first output light beam La3. The second image coupling-out element 323b is configured to diffract the diffracted second light beam Lb propagating in the light-transmitting substrate 121 into a second output light beam Lb3. The third image coupling-out element 323c is configured to diffract the diffracted third light beam Lc propagating in the light-transmitting substrate 121 into a third output light beam Lc3. The fourth image coupling-out element 323d is configured to diffract the diffracted fourth light beam Ld propagating in the light-transmitting substrate 121 into a fourth output light beam Ld3.

It should be pointed out that the first image coupling-out element 323a conforms to a first diffraction wave function, the second image coupling-out element 323b conforms to a second diffraction wave function, the third image coupling-out element 323c conforms to a third diffraction wave function, and the fourth image coupling-out element 323d conforms to a fourth diffraction wave function. The first diffraction wave function, the second diffraction wave function, the third diffraction wave function, and the fourth diffraction wave function are different from each other. The first diffraction wave function, the second diffraction wave function, the third diffraction wave function, and the fourth diffraction wave function are wave functions of different fields of view of virtual image, respectively.

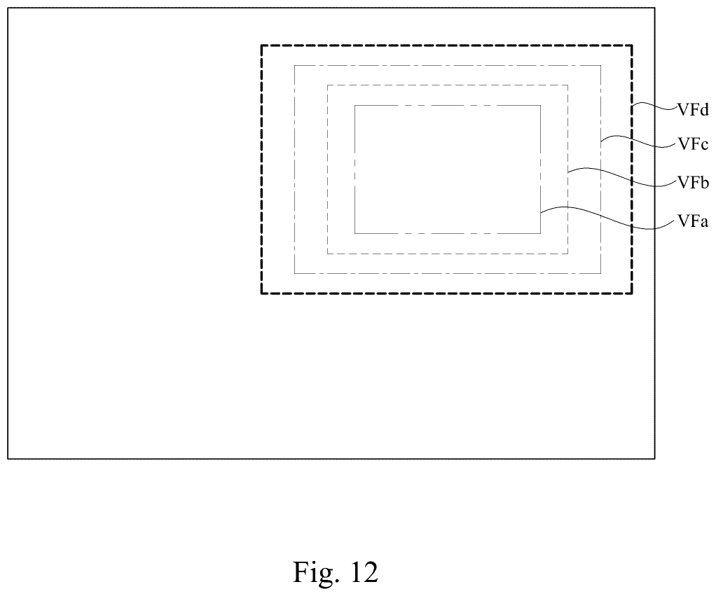

Reference is made to FIG. 12. FIG. 12 is a schematic diagram of different fields of view of virtual image. As shown in FIGS. 11A and 12, the virtual image presented by the first output light beam La3 will correspond to a first field of view of virtual image VFa in FIG. 12 viewed by the eye of the user. As shown in FIGS. 11B and 12, the virtual image presented by the second output light beam Lb3 will correspond to a second field of view of virtual image VFb in FIG. 12 viewed by the eye of the user. As shown in FIGS. 11C and 12, the virtual image presented by the third output light beam Lc3 will correspond to a third field of view of virtual image VFc in FIG. 12 viewed by the eye of the user. As shown in FIGS. 11D and 12, the virtual image presented by the fourth output light beam Ld3 will correspond to a fourth field of view of virtual image VFd in FIG. 12 viewed by the eye of the user. For example, the first field of view of virtual image VFa of the first diffraction wave function is about 60 degrees, the second field of view of virtual image VFb of the second diffraction wave function is about 50 degrees, the third field of view of virtual image VFc of the third diffraction wave function is about 40 degrees, and the fourth field of view of virtual image VFd of the fourth diffraction wave function is about 30 degrees, but the present disclosure is not limited thereto.

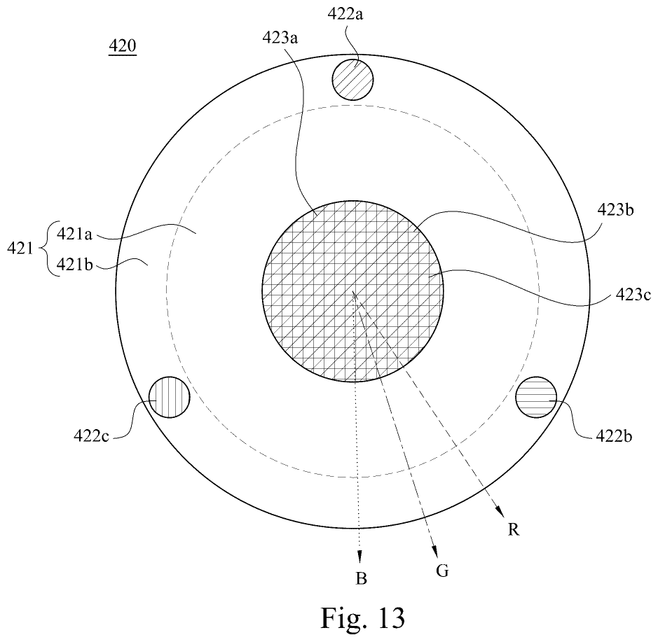

Reference is made to FIG. 13. FIG. 13 is a front view of a waveguide device 420 according to another embodiment of the present disclosure. As shown in FIG. 13, in the present embodiment, the waveguide device 420 includes a light-transmitting substrate 421, a first image coupling-in element 422a, a first image coupling-out element 423a, a second image coupling-in element 422b, a second image coupling-out element 423b, a third image coupling-in element 422c, and a third image coupling-out element 423c. The light-transmitting substrate 421 includes a central region 421a and a peripheral region 421b surrounding the central region 421a. The first image coupling-in element 422a is located in the peripheral region 421b and is configured to diffract a first light beam La (with reference to FIG. 3A) to propagate in the light-transmitting substrate 421. The first image coupling-out element 423a is located in the central region 421a and is configured to diffract the diffracted first light beam La propagating in the light-transmitting substrate 421. The second image coupling-in element 422b is located in the peripheral region 421b and is configured to diffract a second light beam Lb (with reference to FIG. 3B) to propagate in the light-transmitting substrate 421. The second image coupling-out element 423b is located in the central region 421a and is configured to diffract the diffracted second light beam Lb propagating in the light-transmitting substrate 421. The third image coupling-in element 422c is located in the peripheral region 421b and is configured to diffract a third light beam Lc (with reference to FIG. 3C) to propagate in the light-transmitting substrate 421. The third image coupling-out element 423c is located in the central region 421a and is configured to diffract the diffracted third light beam Lc propagating in the light-transmitting substrate 421.

Specifically, in the present embodiment, the first image coupling-out element 423a includes a first diffraction grating, the second image coupling-out element 423b includes a second diffraction grating, and the third image coupling-out element 423c includes a third diffraction grating. The first diffraction grating, the second diffraction grating, and the third diffraction grating intersect each other. That is, the first diffraction grating, the second diffraction grating, and the third diffraction grating physically pass through each other. As such, the waveguide device 420 can have a small size.

In the present embodiment, the first diffraction grating of the first image coupling-out element 423a is configured to diffract red light R. For example, the wavelength of the first light beam La diffracted by the first diffraction grating of the first image coupling-out element 423a is about 632 nm (which is within the wavelength band of the red light R). The second diffraction grating of the second image coupling-out element 423b is configured to diffract green light G. For example, the wavelength of the second light beam Lb diffracted by the second diffraction grating of the second image coupling-out element 423b is about 532 nm (which is within the wavelength band of the green light G). The third diffraction grating of the third image coupling-out element 423c is configured to diffract blue light B. For example, the wavelength of the third light beam Lc diffracted by the third diffraction grating of the third image coupling-out element 423c is about 465 nm (which is within the wavelength band of the blue light B).

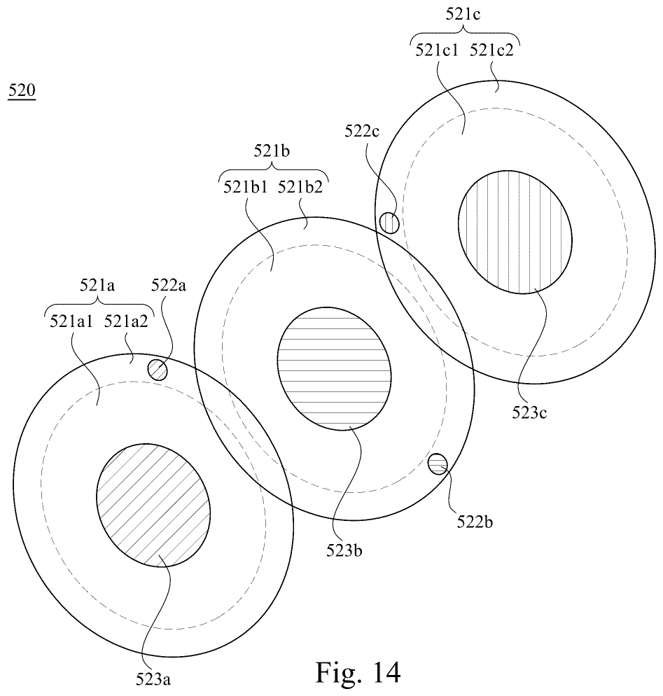

Reference is made to FIG. 14. FIG. 14 is a front view of a waveguide device 520 according to another embodiment of the present disclosure. As shown in FIG. 14, in the present embodiment, the waveguide device 420 includes light-transmitting substrates 521a, 521b, 521c, a first image coupling-in element 522a, a first image coupling-out element 523a, a second image coupling-in element 522b, a second image coupling-out element 523b, a third image coupling-in element 522c, and a third image coupling-out element 523c. The functions of the first image coupling-in element 522a, the first image coupling-out element 523a, the second image coupling-in element 522b, the second image coupling-out element 523b, the third image coupling-in element 522c, and the third image coupling-out element 523c are identical to those of the first image coupling-in element 422a, the first image coupling-out element 423a, the second image coupling-in element 422b, the second image coupling-out element 423b, the third image coupling-in element 422c, and the third image coupling-out element 423c, respectively. The differences between the embodiments as shown in FIGS. 13 and 14 are discussed below.

As shown in FIG. 14, in the present embodiment, the light-transmitting substrate 521a includes a central region 521a1 and a peripheral region 521a2 surrounding the central region 521a1. The light-transmitting substrate 521b includes a central region 521b1 and a peripheral region 521b2 surrounding the central region 521b1. The light-transmitting substrate 521c includes a central region 521c1 and a peripheral region 521c2 surrounding the central region 521c1. The first image coupling-in element 522a and the first image coupling-out element 523a are respectively located in the peripheral region 521a2 and the central region 521a1 of the light-transmitting substrate 521a. The second image coupling-in element 522b and the second image coupling-out element 523b are respectively located in the peripheral region 521b2 and the central region 521b1 of the light-transmitting substrate 521b. The third image coupling-in element 522c and the third image coupling-out element 523c are respectively located in the peripheral region 521c2 and the central region 521c1 of the light-transmitting substrate 521c. That is, a combination of the light-transmitting substrate 521a, the first image coupling-in element 522a, and the first image coupling-out element 523a is responsible for diffracting the red light R, a combination of the light-transmitting substrate 521b, the second image coupling-in element 522b, and the second image coupling-out element 523b is responsible for diffracting the green light G, and a combination of the light-transmitting substrate 521c, the third image coupling-in element 522c, and the third image coupling-out element 523c is responsible for diffracting the blue light B.

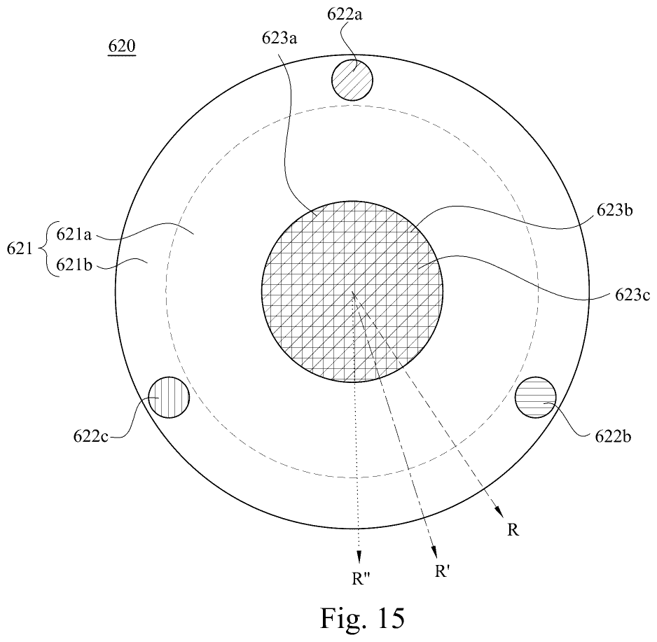

Reference is made to FIG. 15. FIG. 15 is a front view of a waveguide device 620 according to another embodiment of the present disclosure. As shown in FIG. 15, in the present embodiment, the waveguide device 620 includes a light-transmitting substrate 621, a first image coupling-in element 622a, a first image coupling-out element 623a, a second image coupling-in element 622b, a second image coupling-out element 623b, a third image coupling-in element 622c, and a third image coupling-out element 623c. The light-transmitting substrate 621 includes a central region 621a and a peripheral region 621b surrounding the central region 621a. The first image coupling-in element 622a is located in the peripheral region 621b and is configured to diffract a first light beam La (with reference to FIG. 3A) to propagate in the light-transmitting substrate 621. The first image coupling-out element 623a is located in the central region 621a and is configured to diffract the diffracted first light beam La propagating in the light-transmitting substrate 621. The second image coupling-in element 622b is located in the peripheral region 621b and is configured to diffract a second light beam Lb (with reference to FIG. 3B) to propagate in the light-transmitting substrate 621. The second image coupling-out element 623b is located in the central region 621a and is configured to diffract the diffracted second light beam Lb propagating in the light-transmitting substrate 621. The third image coupling-in element 622c is located in the peripheral region 621b and is configured to diffract a third light beam Lc (with reference to FIG. 3C) to propagate in the light-transmitting substrate 621. The third image coupling-out element 623c is located in the central region 621a and is configured to diffract the diffracted third light beam Lc propagating in the light-transmitting substrate 621.

Specifically, in the present embodiment, the first image coupling-out element 623a includes a first diffraction grating, the second image coupling-out element 623b includes a second diffraction grating, and the third image coupling-out element 623c includes a third diffraction grating. The first diffraction grating, the second diffraction grating, and the third diffraction grating intersect each other. That is, the first diffraction grating, the second diffraction grating, and the third diffraction grating physically pass through each other. As such, the waveguide device 620 can have a small size.

In the present embodiment, the first diffraction grating of the first image coupling-out element 623a is configured to diffract red light R to propagate with a first range of diffraction angle. For example, the first diffraction grating of the first image coupling-out element 623a is configured to diffract light of which the wavelength is about 632 nm to propagate with a first diffraction angle (as indicated by the red light R shown in FIG. 15). The second diffraction grating of the second image coupling-out element 623b is configured to diffract the red light R to propagate with a second range of diffraction angle. For example, the second diffraction grating of the second image coupling-out element 623b is configured to diffract light of which the wavelength is about 632 nm to propagate with the first diffraction angle plus 5 degrees (as indicated by red light R′ shown in FIG. 15). The third diffraction grating of the third image coupling-out element 623c is configured to diffract the red light R to propagate with a third range of diffraction angle. For example, the third diffraction grating of the third image coupling-out element 623c is configured to diffract light of which the wavelength is about 632 nm to propagate with the first diffraction angle plus 10 degrees (as indicated by red light R″ shown in FIG. 15).

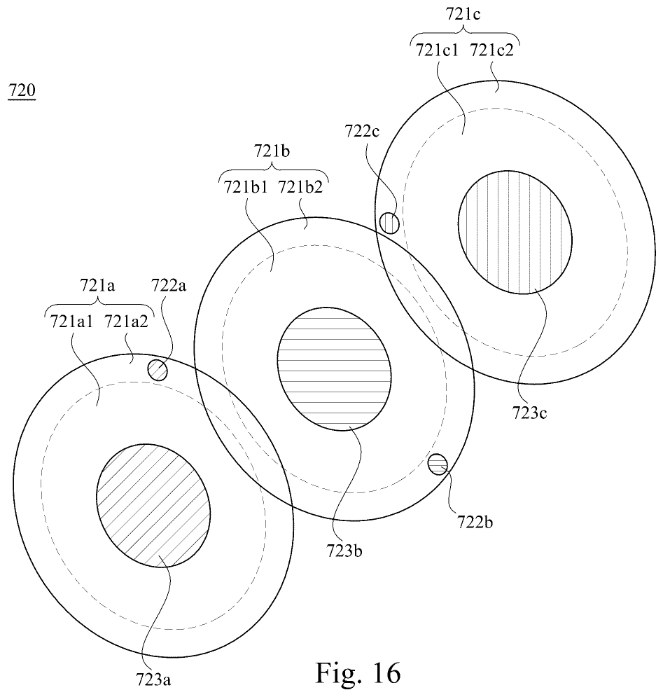

Reference is made to FIG. 16. FIG. 16 is a front view of a waveguide device 720 according to another embodiment of the present disclosure. As shown in FIG. 16, in the present embodiment, the waveguide device 720 includes light-transmitting substrates 721a, 721b, 721c, a first image coupling-in element 722a, a first image coupling-out element 723a, a second image coupling-in element 722b, a second image coupling-out element 723b, a third image coupling-in element 722c, and a third image coupling-out element 723c. The functions of the first image coupling-in element 722a, the first image coupling-out element 723a, the second image coupling-in element 722b, the second image coupling-out element 723b, the third image coupling-in element 722c, and the third image coupling-out element 723c are identical to those of the first image coupling-in element 622a, the first image coupling-out element 623a, the second image coupling-in element 622b, the second image coupling-out element 623b, the third image coupling-in element 622c, and the third image coupling-out element 623c, respectively. The differences between the embodiments as shown in FIGS. 15 and 16 are discussed below.

As shown in FIG. 16, in the present embodiment, the light-transmitting substrate 721a includes a central region 721a1 and a peripheral region 721a2 surrounding the central region 721a1. The light-transmitting substrate 721b includes a central region 721b1 and a peripheral region 721b2 surrounding the central region 721b1. The light-transmitting substrate 721c includes a central region 721c1 and a peripheral region 721c2 surrounding the central region 721c1. The first image coupling-in element 722a and the first image coupling-out element 723a are respectively located in the peripheral region 721a2 and the central region 721a1 of the light-transmitting substrate 721a. The second image coupling-in element 722b and the second image coupling-out element 723b are respectively located in the peripheral region 721b2 and the central region 721b1 of the light-transmitting substrate 721b. The third image coupling-in element 722c and the third image coupling-out element 723c are respectively located in the peripheral region 721c2 and the central region 721c1 of the light-transmitting substrate 721c. That is, a combination of the light-transmitting substrate 721a, the first image coupling-in element 722a, and the first image coupling-out element 723a is responsible for diffracting the red light R to propagate with the first diffraction angle, a combination of the light-transmitting substrate 721b, the second image coupling-in element 722b, and the second image coupling-out element 723b is responsible for diffracting the red light R to propagate with the first diffraction angle plus 5 degrees, and a combination of the light-transmitting substrate 721c, the third image coupling-in element 722c, and the third image coupling-out element 723c is responsible for diffracting the red light R to propagate with the first diffraction angle plus 10 degrees.

According to the foregoing recitations of the embodiments of the disclosure, it can be seen that in the waveguide device and optical device using the same of the present disclosure, by locating a plurality of image coupling-in elements in the peripheral region of the light-transmitting substrate and correspondingly locating a plurality of image coupling-out elements in the central region of the light-transmitting substrate, independent light guiding and output control of a plurality of light beams can be achieved. In this way, the waveguide device and optical device of the present disclosure can effectively solve the bottlenecks encountered in the prior art, such as potential limitations in position, distance of virtual image, or field of view of virtual image, thereby providing a more flexible and diversified virtual image presentation effect.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A waveguide device, comprising:
at least one light-transmitting substrate comprising a central region and a peripheral region surrounding the central region;
a first image coupling-in element located in the peripheral region and configured to diffract a first light beam to propagate in the at least one light-transmitting substrate;
a first image coupling-out element located in the central region and configured to diffract the diffracted first light beam propagating in the at least one light-transmitting substrate;
a second image coupling-in element located in the peripheral region and configured to diffract a second light beam to propagate in the at least one light-transmitting substrate; and
a second image coupling-out element located in the central region and configured to diffract the diffracted second light beam propagating in the at least one light-transmitting substrate.

2. The waveguide device of claim 1, wherein the first image coupling-in element and the first image coupling-out element are aligned radially, and the second image coupling-in element and the second image coupling-out element are aligned radially.

3. The waveguide device of claim 1, wherein the first light beam and the second light beam have an identical wavelength.

4. The waveguide device of claim 3, wherein the first image coupling-out element is configured to diffract the diffracted first light beam to propagate with a first diffraction angle, and the second image coupling-out element is configured to diffract the diffracted second light beam to propagate with a second diffraction angle different from the first diffraction angle.

5. The waveguide device of claim 3, wherein the first image coupling-out element conforms to a first diffraction wave function, and the second image coupling-out element conforms to a second diffraction wave function different from the first diffraction wave function.

6. The waveguide device of claim 5, wherein the first diffraction wave function is a wave function of a first distance of virtual image, and the second diffraction wave function is a wave function of a second distance of virtual image different from the first distance of virtual image.

7. The waveguide device of claim 5, wherein the first diffraction wave function is a wave function of a first field of view of virtual image, and the second diffraction wave function is a wave function of a second field of view of virtual image different from the first field of view of virtual image.

8. The waveguide device of claim 1, wherein the first image coupling-out element comprises a first diffraction grating, the second image coupling-out element comprises a second diffraction grating, and the first diffraction grating and the second diffraction grating intersect each other.

9. The waveguide device of claim 1, wherein the at least one light-transmitting substrate comprises a first light-transmitting substrate and a second light-transmitting substrate, the first image coupling-in element and the first image coupling-out element are located on the first light-transmitting substrate, and the second image coupling-in element and the second image coupling-out element are located on the second light-transmitting substrate.

10. The waveguide device of claim 9, wherein the first light beam and the second light beam have different wavelengths.

11. The waveguide device of claim 9, wherein the first light beam and the second light beam have an identical wavelength.

12. The waveguide device of claim 1, wherein the central region is rotatably connected to the peripheral region.

13. An optical device, comprising:
a housing;
a waveguide device comprising:
at least one light-transmitting substrate rotatably connected to the housing and comprising a central region and a peripheral region surrounding the central region;
a first image coupling-in element located in the peripheral region and configured to diffract a first light beam to propagate in the at least one light-transmitting substrate;
a first image coupling-out element located in the central region and configured to diffract the diffracted first light beam propagating in the at least one light-transmitting substrate;
a second image coupling-in element located in the peripheral region and configured to diffract a second light beam to propagate in the at least one light-transmitting substrate; and
a second image coupling-out element located in the central region and configured to diffract the diffracted second light beam propagating in the at least one light-transmitting substrate; and
a projector disposed on the housing and configured to emit the first light beam and the second light beam toward the peripheral region along an optical path.

14. The optical device of claim 13, wherein the first light beam and the second light beam have an identical wavelength.

15. The optical device of claim 14, wherein the first image coupling-out element is configured to diffract the diffracted first light beam to propagate with a first diffraction angle, and the second image coupling-out element is configured to diffract the diffracted second light beam to propagate with a second diffraction angle different from the first diffraction angle.

16. The optical device of claim 14, wherein the first image coupling-out element conforms to a first diffraction wave function, and the second image coupling-out element conforms to a second diffraction wave function different from the first diffraction wave function.

17. The optical device of claim 16, wherein the first diffraction wave function is a wave function of a first distance of virtual image, and the second diffraction wave function is a wave function of a second distance of virtual image different from the first distance of virtual image.

18. The optical device of claim 16, wherein the first diffraction wave function is a wave function of a first field of view of virtual image, and the second diffraction wave function is a wave function of a second field of view of virtual image different from the first field of view of virtual image.

19. The optical device of claim 13, wherein the first image coupling-out element comprises a first diffraction grating, the second image coupling-out element comprises a second diffraction grating, and the first diffraction grating and the second diffraction grating intersect each other.

20. The optical device of claim 13, wherein the central region is rotatably connected to the peripheral region.
